(19) United States
(12) Patent Application Publication
(10) Pub. No.: US 2025/0011533 A1
(43) Pub. Date: Jan. 9, 2025

(54) SHRINKABLE POLYESTER FILMS WITH REDUCED SHRINKAGE

(71) Applicant: Eastman Chemical Company, Kingsport, TN (US)

(72) Inventors: Mark Allen Peters, Jonesborough, TN (US); Huamin Hu, Kingsport, TN (US); Marc Alan Strand, Kingsport, TN (US); Jacob E. Napierala, Johnson City, TN (US)

(73) Assignee: Eastman Chemical Company, Kingsport, TN (US)

(21) Appl. No.: 18/697,896

(22) PCT Filed: Apr. 5, 2022
(86) PCT No.: PCT/US2022/023405

§ 371 Date: Apr. 2, 2024

Related U.S. Application Data
(60) Provisional application No. 63/262,252, filed on Oct. 8, 2021.

(51) Int. Cl. C08G 63/183; C08G 63/199; C08G 63/672; C08J 5/18; C08L 67/02

(52) U.S. Cl. CPC C08G 63/183; C08G 63/199; C08G 63/672; C08J 5/18; C08L 67/025; C08J 2367/02; C08L 2205/025; C08L 2207/20

(57) ABSTRACT

The polyester compositions of the invention are useful in the manufacture of shrinkable films. The shrinkable films of the invention are comprised of polyester compositions comprising certain combinations of glycols and dicarboxylic acids in particular proportions which provide a lower level of shrinkage while having a melting temperature to accommodate modern sorting and recycling technologies.

### FIELD OF THE INVENTION

The invention relates generally to shrinkable polyester films comprising polyester compositions having a combination of certain compositional ranges having improved properties

### BACKGROUND OF THE INVENTION

Thermoshrinkable plastic films are used as coverings, to hold objects together, and as an outer wrapping for bottles, cans and other kinds of containers. For example, such films are used for covering the cap, neck, shoulder or bulge of bottles or the entire bottle for the purpose of labeling, protection, parceling, or increasing the value of the product. The uses mentioned above take advantage of the shrinkability created by the internal shrink stress of the film. The films must be tough, must shrink in a controlled manner, and must provide enough shrink force to hold itself on the bottle without crushing the contents. Thermoshrinkable films can be made from a variety of raw materials to meet a range of material demands.

Polyester-based thermoshrinkable film compositions have been used commercially as shrinkable film labels for food, beverage, personal care, household goods, etc. Often, these shrinkable films are used in combination with a clear polyethylene terephthalate (PET) bottle or container. The total package (bottle plus label) can be placed in the recycling process. In a typical recycling center, the PET and the shrinkable film material can end up together at the end of the process due to similarities in composition and density. Drying of the recycled PET flake (referred to as rPET flake) is required to remove residual water that remains with the rPET through the recycling process. Typically, rPET is dried at temperatures above 200° C. At those temperatures, typical polyester shrink film resins will soften and become sticky, often creating clumps with PET flakes. These clumps must be removed before further processing. These clumps reduce the yield of rPET flake from the process and create an additional handling step. In general, clumping evaluations are conducted using the APR clump test: PET-S-08 PET Flake Clumping Evaluation revision date Nov. 16, 2018 and determinations regarding the suitability of a recycle stream are evaluated in accordance with the “Critical Guidance Protocol for Clear PET Articles with Labels and Closures”, dated Apr. 11, 2019, Document No. PET-CG-02.

Currently, it is highly desirable that consumer packaging materials be made of materials which can be readily recycled (as is the case with polyesters), contain recycled material, or be made with materials that are not considered to be harmful to the environment either as a raw material or as a final polymeric material. Recyclers of plastic containers must take advantage of automated processes to sort and process materials that enter post-consumer recycling processes. The automated processes need to separate materials based on their chemical composition (e.g., HDPE vs PET), color (colorless vs colored, blue and green vs other colors), and remove ferrous materials from the plastic streams. The Association for Plastic Recyclers (APR) has recommended that a significant portion of the primary package needs to be exposed to allow efficient sortation. In this way, the sortation equipment can determine the identity of the container and sort based on container properties rather than the identity of the label used to cover that container. If this recommendation is adopted across product portfolios, the ultimate or maximum shrinkage requirement for shrinkable labels would be reduced because high shrinkage is only required with full-body shrinkable film labels that are applied to bottles and are designed such that the diameter of the bottles varies greatly from the top to the bottom of the bottle. In general, these new labels will require less than 70% ultimate shrinkage (shrinkage at 95° C.), because the labels will essentially be directed to covering only the larger diameter portion(s) of the container, and thus require less shrinkage in order to form a proper shrink film coverage. Moreover, films which are optimally compatible with PET recycling must also have a strain induced melting point greater than 200° C. as described in WO2020/076747. The high strain induced crystalline melting point is a key characteristic of a shrinkable film that defines whether the film can be efficiently recycled along with PET in the PET recycling process.

### SUMMARY OF THE INVENTION

The polyester compositions of the invention are useful in the manufacture of shrinkable films. The shrinkable films of the invention are comprised of polyester compositions comprising certain combinations of glycols and dicarboxylic acids in particular proportions. These compositions afford certain advantageous properties in the resulting shrinkable films.

We have discovered that the ultimate shrinkage properties of a film can be modified by controlling the monomer content of the shrink film resin used to make the film. Additionally, the new monomer compositional targets will provide resins, which when converted into shrinkable films, will be recyclable in traditional PET recycling processes. It has also been found that the identity and proportion of specific combinations of glycol monomers are important to produce films with shrink film properties that better match those of films useful in these new labelling application recommendations. Additionally, the right choice of processing conditions is important to further modify the shrinkable film properties of films made with identical chemical compositions. This invention describes unique and unexpected effects measured with certain monomer combinations which improve the performance of the polyester shrink film label to better match the performance of shrinkable films required to meet the new labelling recommendations for the shrinkable film market. In this fashion, the films will generally be required to shrink less (i.e., <70% ultimate shrinkage at ˜95° C.), which level of shrinkage is necessary given this focus on the intended coverage of the shrink film to only the large(r) diameter portion(s) of the container.

Additionally, the compositions of the invention are useful as articles of manufacture, such as shaped or formed articles, extruded sheets and films, and as labels or sleeves for various articles, such as containers. In one embodiment, the shaped or formed articles are useful as components of medical devices.

### BRIEF DESCRIPTION OF THE DRAWINGS

FIG. 1 is a comparison of shrinkage (Transverse Direction, Main Shrinkage direction) for films made with resins containing different contents of amorphous monomers.

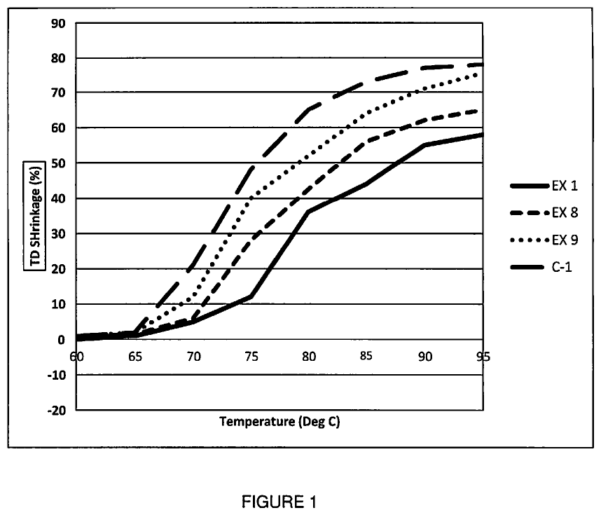

In this graph,
TD (Ex1) refers to the TD (Transverse Direction) shrinkage of a shrinkable film made with a resin described by Example 1 that has an amorphous monomer content of <20 mole %;
TD (Ex8) refers to the TD shrinkage of a shrinkable film made with a resin described by Example 8 that has an amorphous monomer content between 20 and 23 mole %;
TD (Ex9) refers to the TD shrinkage of a shrinkable film made with a resin described by Example 9 that has an amorphous monomer content between 23 and 35 mole %; and
C-1 refers to the TD shrinkage of a shrinkable film made with a resin described by comparative Example 1 that has an amorphous monomer content of 35 mole %.

### DETAILED DESCRIPTION OF THE INVENTION

In a first aspect, the invention provides a polyester composition comprising a polyester chosen from A and B:
A. a polyester comprising:
   a. a dicarboxylic acid component comprising:
      greater than about 75 mole percent of terephthalic acid residues;
      about 0 to about 25 mole percent of isophthalic acid residues; and
   b. a glycol component comprising:
      about 60 to about 90 mole percent of ethylene glycol residues; and
      about 0.1 to about 30 mole percent of residues chosen from 2,2-dimethylpropane-1,3-diol residues and 1,4-cyclohexanedimethanol residues; and
      about 0 to about 15 mole percent total of diethylene glycol residues; and
B. a polyester comprising:
   a. a dicarboxylic acid component comprising:
      100 mole percent of dicarboxylic acid residues chosen from aliphatic, alicyclic, and aromatic dicarboxylic acids, provided the aromatic dicarboxylic acids are other than terephthalic acid; and
   b. a glycol component comprising:
      100 mole percent of glycol residues;
      provided that the glycol component comprises less than about 23 mole percent of glycol residues capable of forming amorphous segments in the polyester;
wherein the polyester composition has an inherent viscosity of about 0.5 to about 0.9 dL/g, measured in a 60/40 parts by weight solution of phenol/tetrachloroethane, at 250° C. and at a concentration of about 0.5 g of polymer in 100 mL of solution;
wherein the polyester exhibits a strain-induced crystalline melting point of about 190° C. to about 240° C.; and
wherein the total mole percent of the dicarboxylic acid component is 100 mole percent, and wherein the total mole percent of the glycol component is 100 percent.

As set forth above, the polyester composition(s) may comprise (i) at least one polyester as set forth in paragraph A., above, or (ii) the polyester composition(s) may comprise at least one polyester as set forth in paragraph B., above, or (iii) the polyester compositions may comprise one or more polyesters comprising those set forth in paragraph A., and one or more polyesters as set forth in paragraph B.

In one embodiment, the polyester as set forth in paragraph A. is comprised of a dicarboxylic acid component comprising:
(i) greater than about 90 mole percent of terephthalic acid residues;
(ii) about 0 to about 10 mole percent of isophthalic acid residues.

In other embodiments, the dicarboxylic acid component comprises greater than about 90 mole percent of terephthalic acid residues and about 0 to about 5 or about 0.1 to about 5 mole percent of isophthalic acid residues.

In one embodiment, the glycol residues capable of forming amorphous segments in the polyester are chosen from 2,2,4-trimethyl-1,3-pentanediol; 2-propoxy-1,3-propanediol; 2-methyl-2-propyl-1,3-propanediol; 2,2-dimethyl-1,3-propanediol; diethylene glycol; 1,4-cyclohexanedimethanol; 1,3-cyclohexanedimethanol; 2,2′,4,4′-tetramethyl-1,3-cyclobutanediol; dimers of cyclohexanedimethanol; triethylene glycol; 1,3-propanediol; 2-methyl-1,3-propanediol; 1,4-butanediol; 2-propoxy-1,3-propanediol; polytetramethylene ether glycol; and polyethylene glycol.

In another embodiment, A. is a polyester comprising:
a. a dicarboxylic acid component comprising greater than about 90 mole percent of terephthalic acid residues;
b. a glycol component comprising: about 75 mole percent to about 90 mole percent of ethylene glycol residues; about 0.1 to about 20 mole percent of residues chosen from either 2,2-dimethyl-1,3-propanediol or 1,4-cyclohexanedimethanol; and about 0 to about 5 mole percent total of diethylene glycol residues.

In other embodiments, the glycol component comprises about 0 to about 5 mole percent, or about 0.1 to about 4 mole percent of total diethylene glycol residues, i.e., diethylene glycol residues resulting from that added to the reaction mixture along with those formed as a consequence of the presence of ethylene glycol. In this regard, it will be understood that as a consequence of using ethylene glycol in a polyester polymerization reaction, varying percentages of diethylene glycol may be formed in situ. As used herein, references to “total” diethylene glycol residues refers to the mole percentages of those residues which result both from diethylene glycol which may be added to the reaction mixture as well as those residues which are formed in situ.

In another embodiment, B. a. is comprised of dicarboxylic acid residues chosen from residues of adipic, succinic, glutaric, azelaic, sebacic, 1,3-cyclohexanedicarboxylic, isophthalic acid, 1,4-cyclohexanedicarboxylic acid, succinic acid, adipic acid, and hexahydrophthalic anhydride.

In another embodiment, the glycol component of polyester A. or polyester B., above, is comprised of about 80 to about 85 mole percent of ethylene glycol residues, about 3 to about 5 mole percent of total diethylene glycol residues, about 1.7 to about 2.4 mole percent of 1,4-cyclohexanedimethanol residues, and about 9 to about 13 mole percent of 2,2-dimethyl-1,3-propanediol residues.

In another embodiment, the glycol component of polyester A. or polyester B., above, is comprised of about 77 to about 83 mole percent of ethylene glycol residues, about 5 to about 7 mole percent of total diethylene glycol residues, and about 13 to about 16 mole percent of 2,2-dimethyl-1,3-propanediol residues.

In another embodiment, B. b. is comprised of about 68 to about 88 mole percent of ethylene glycol residues; about 2.8 to about 7.5 mole percent of total diethylene glycol residues; from 0 to about 2.5 mole percent of 1,4-cyclohexanedimethanol; and 9 to about 12 mole percent of 2,2-dimethyl-1,3-propanediol.

In another embodiment, B. b. is comprised of about 70 to about 88 mole percent of ethylene glycol residues; about 2.8 to about 7.5 mole percent of total diethylene glycol residues; from 0 to about 6.2 mole percent of 1,4-cyclohexanedimethanol residues; and 9 to about 17 mole percent of 2,2-dimethyl-1,3-propanediol residues.

In another embodiment, the polyester composition comprises a polyester comprising:
a. a dicarboxylic acid component comprising:
   about 95 to about 100 mole percent of terephthalic acid residues;
   about 0 to about 5 mole percent of dicarboxylic acid residues chosen from residues of adipic acid, succinic acid, glutaric acid, azelaic acid, sebacic acid, 1,3-cyclohexanedicarboxylic acid, isophthalic acid. 1,4-cyclohexanedicarboxylic acid, and hexahydrophthalic anhydride and
b. a glycol component comprising:
   about 80 to about 90 mole percent of ethylene glycol residues;
   about 9 to about 13 mole percent of residues of 2,2-dimethylpropane-1,3-diol; and
   about 3 to about 7 mole percent of total diethylene glycol residues; and
wherein the total mole percent of the dicarboxylic acid component is 100 mole percent, and wherein the total mole percent of the glycol component is 100 percent.

In another embodiment, the dicarboxylic acid component comprises about 0 to about 5 mole percent of residues of isophthalic acid.

As used herein, the phrase “capable of forming amorphous domains or regions within a polymeric material” refers to glycol residues which, along with the recited dicarboxylic acid residues, form amorphous domains or regions in the polymeric material. In other words, such glycols, if used solely as the glycol component, along with the recited dicarboxylic acid residues would form an amorphous homopolymer. In certain embodiments, glycol residues which are capable of forming amorphous segments in the polyester are chosen from diethylene glycol; triethylene glycol; 1,4-cyclohexanedimethanol; 2,2-dimethyl-1,3-propanediol; 2,2,4-trimethyl-1,3-pentanediol (TMPD); 2-propoxy 1,3-propanediol (2-PP); 2-methyl-2-propyl-1,3-propanediol (2-MPP); 1,3-cyclohexanedimethanol (1,3-CHDM); 2,2′,4,4′-tetramethyl-1,3-cyclobutanediol (TMCD); CHDM dimers; triethylene glycol (TEG); 1,3-propanediol (1,3-PD); 2-methyl-1,3-propanediol (MPDiol); 1,4-butanediol (1,4-BDO); 2-propoxy-1,3-propanediol; 2-propoxy 1,3-propanediol; polytetramethylene ether glycol (PTMG); and “heavy TEG” (a mixture of tetraethylene glycol, TEG and PEG.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “dicarboxylic acid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a glycol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a glycol to make a polyester.

The polyesters used in the present invention typically can be prepared from dicarboxylic acids and glycols which react in substantially equal proportions and are incorporated into the polyester polymer as their corresponding residues. The polyesters of the present invention, therefore, can contain substantially equal molar proportions of acid residues (100 mole %) and glycol (and/or multifunctional hydroxyl compound) residues (100 mole %) such that the total moles of repeating units is equal to 100 mole %. The mole percentages provided in the present invention, therefore, may be based on the total moles of acid residues, the total moles of glycol residues, or the total moles of repeating units.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present invention. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein.

Esters of terephthalic acid and the other dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In another embodiment, at least a portion of the residues derived from dicarboxylic acids and glycols as set forth herein, are derived from recycled monomeric species such as recycled dimethylterephthalate (rDMT), recycled terephthalic acid (rTPA), recycled dimethylisopthalate (rDMI), recycled ethylene glycol (rEG), recycled cyclohexanedimethanol (rCHDM), and recycled diethylene glycol (rDEG). Such recycled monomeric species can be obtained from known methanolysis or glycolysis reactions which are utilized to depolymerize various post-consumer recycled polyesters and copolyesters. Similarly, recycled poly(ethylene terephthalate) (rPET) can be utilized as a feedstock (for the dicarboxylic acid and glycol components) in the manufacturing of polyesters of the invention having recycle content. Accordingly, in another embodiment, the polyester compositions of the invention comprise at least a portion of the dicarboxylic acid residues and/or glycol residues are derived from (i) recycled monomeric species chosen from rDMT, rTPA, rDMI, rEG, rCHDM, rDEG, and (ii) rPET, provided that the glycol component of the polyester so manufactured, comprises less than about 23 mole percent of glycol residues capable of forming amorphous segments in the polyester.

In one embodiment, the glycol component of the polyester compositions useful in the present invention can comprise 1,4-cyclohexanedimethanol. In another embodiment, the glycol component of the polyester compositions useful in the present invention comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

In some embodiments, the polyesters according to the present invention can comprise from 0 to 10 mole %, for example, from 0.01 to 5 mole %, from 0.01 to 1 mole %, from 0.05 to 5 mole %, from 0.05 to 1 mole %, or from 0.1 to 0.7 mole %, based the total mole percentages of either the glycol or dicarboxylic acid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In some embodiments, the polyester(s) useful in the present invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, incorporated herein by reference.

The polyesters of the invention can also comprise at least one chain extender. Suitable chain extenders include, but are not limited to, multifunctional (including, but not limited to, bifunctional) isocyanates, multifunctional epoxides, including, for example, epoxylated novolac polymers, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

In certain embodiments, the polyesters of the invention possess an inherent viscosity of about 0.5 to about 0.9 dL/g, measured in a 60/40 parts by weight solution of phenol/tetrachloroethane at 250° C. In certain embodiments, the polyesters of the disclosure can exhibit at least one of the following inherent viscosities: 0.50 to about 0.90 dL/g, about 0.60 to about 0.80 dL/g; about 0.55 to about 0.85 dL/g; or about 0.65 to about 0.75 dL/g; as determined in 60/40 (weight/weight) phenol/tetrachloroethane at a concentration of 0.25 g/50 ml at 250° C. Films made with copolyester resins that have an inherent viscosity lower than 0.5 dL/g are generally too brittle, and thus disfavored for shrink film applications, while polyesters of at least 0.3 dL/g are required for minimal physical properties.

The glass transition temperature (Tg) of the polyesters is determined using a TA DSC 2920 from Thermal Analyst Instrument at a scan rate of 20° C./minute. In certain embodiments, the Tg of the polyesters of the invention are about 60° to about 80° C., or about 70° to about 80° C. In certain embodiments, these Tg ranges can be met with or without at least one plasticizer being added during polymerization.

In one embodiment, the polyesters of the invention can be visually clear. The term “visually clear” is defined herein as an appreciable absence of cloudiness, haziness, and/or muddiness, when inspected visually.

The polyesters useful in this invention can be made by processes known from the literature, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure of which is incorporated herein by reference.

In general, the polyesters of the invention may be prepared by condensing the dicarboxylic acid or dicarboxylic acid ester with the glycol in the presence of a catalyst at elevated temperatures increased gradually during the course of the condensation up to a temperature of about 225° C. to 310° C., in an inert atmosphere, and conducting the condensation at low pressure during the latter part of the condensation, as described in further detail in U.S. Pat. No. 2,720,507 incorporated herein by reference.

By way of example, processes known for preparing polyesters such as an ester-interchange or esterification stage followed by a polycondensation stage can be utilized. Advantageously, polyester synthesis can be performed as a melt phase process in the absence of organic solvents. The ester-interchange or esterification can be conducted under an inert atmosphere at a temperature of about 150° C. to about 280° C. for about 0.5 to about 8 hours, or from about 180° C. to about 240° C. for about 1 to about 4 hours. The monomers (diacids or glycols) vary in reactivity, depending on processing conditions, but glycol-functional monomers are commonly used in molar excesses of 1.05 to 3 moles per total moles of acid functional monomers. The polycondensation stage is advantageously performed under reduced pressure at a temperature of about 220° C. to about 350° C., or about 240° C. to about 300° C., or about 250° C. to about 290° C. for about 0.1 to about 6 hours, or from about 0.5 to about 3 hours. The reactions during both stages are facilitated by the judicious selection of catalysts known by those skilled in the art, including but not limited to alkyl and alkoxy titanium compounds, alkali metal hydroxides and alkoxides, organotin compounds, germanium oxide, organogermanium compounds, aluminum compounds, manganese salts, zinc salts, rare earth compounds, antimony oxide, and so forth. Phosphorous compounds may be used as stabilizers to control color and reactivity of residual catalysts. Typical examples are phosphoric acid, phosphonic acid, and phosphate esters, such as Merpol™ A, a product of Stepan Chemical Company.

In some embodiments, during the process for making the polyesters useful in the present invention, certain agents which colorize the polymer can be added to the melt, including toners or dyes. In one embodiment, a bluing toner is added to the melt in order to adjust the b* of the resulting polyester polymer melt phase product. Such bluing agents include blue inorganic and organic toner(s) and/or dyes. In addition, red toner(s) and/or dyes can also be used to adjust the a* color. In one embodiment, the polymers useful in the invention and/or the polymer compositions of the invention, with or without toners, can have color values L*, a* and b* which can be determined using a Hunter Lab Ultrascan Spectra Colorimeter manufactured by Hunter Associates Lab Inc., Reston, Va. The color determinations are averages of values measured on either pellets or powders of the polymers or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Advantageously, the toner(s) are added to the esterification zone or to the early stages of the polycondensation zone, such as to a pre-polymerization reactor or added in an extruder

In a further embodiment, the invention provides polyester blends useful in shrink film applications. In one embodiment, the polyester blend comprises:
(a) from 5 to 95 weight % of the polyester compositions of the invention described herein; and
(b) from 5 to 95 weight % of at least one polyester component which is other than the polyester compositions of the invention;
with the proviso that the total mole percent of amorphous glycol monomers in (a) and (b) is less than about 23 mole percent of the total glycols; and wherein the blend exhibits a strain-induced crystalline melting point of about 190° C. to about 240° C.

Suitable examples of such polyester components (b) include, but are not limited to aliphatic-aromatic polyesters. The following polyesters, which can be blended to make the polyester composition blends of the invention, can be included as the polyester component (b) used in additional blending if such blending meets the compositional ranges of the invention as prescribed herein: polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), poly(butylene terephthalate) and/or diethylene glycol modified PET (EASTOBOND™ copolyester). Similarly, each of these recited materials as polyester component (b) may be recycled polymers; in other words, recycled PET (rPET), recycled PETG (rPETG), etc., may be used in the blends of the invention, provided that that the total mole percent of amorphous glycol monomers in (a) and (b) is less than about 23 mole percent of the total glycols (i.e., total glycols in the blend).

The blends can be prepared by conventional processing techniques known in the art, such as melt blending or solution blending.

In certain embodiments, the polyester compositions can also contain from 0.01 to 25% by weight of the overall composition common additives such as colorants, dyes, mold release agents, flame retardants, plasticizers, glass bubbles, voiding agents, nucleating agents, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

As noted, the polyesters of the invention are useful in the manufacture of shrinkable films. The shrinkable films of the invention are comprised of polyesters comprising certain combinations of glycols and diacids as described herein. In certain embodiments, the Tg of such polyesters will be between about 60° and about 80° C. The shrinkage of the films in the main shrinkage direction will be less than about 2% at 60° C., between about 0 and 10% at 65° C., and less than 60% at about 95° C.

As noted, the polyester compositions of the invention will exhibit a strain-induced crystalline melting point of about 190° C. to about 240° C. In this regard, crystalline melting point is determined according to the following methodology:
Stretched films are submitted for thermal properties analysis via DSC.
Glass transition temperature and the strain induced crystalline melting point (Tg and Tm respectively) are thus determined:
   ASTM E1356
   Determined using a TA DSC 2920 from Thermal Analyst Instrument at a scan rate of 20° C./min.
   Tm is measured on the first heat of stretched samples
   Tg is measured during the 2nd heating step.
   Samples could also be crystallized in a forced air oven at 170° C. for 2 h and then analyzed with DSC. For all amorphous but crystallizable samples, a crystalline melting point is typically not present during the second heat of the DSC scan with a heating rate of 20° C./minute can be measured in stretched films or after crystallization in an oven.

In certain embodiments, the shrink films can have a break strain percentage greater than 100% at a stretching speed of 300 mm/minute in the direction orthogonal to the main shrinkage direction according to ASTM Method D882.

In certain embodiments, the shrink films can have an onset of shrinkage temperature of between about 55° C. and about 70° C.

In another aspect, the invention provides shrinkable film(s), extruded sheet(s) and film(s), thermoformed article(s), and molded article(s) of this disclosure comprising the polyesters as described herein. The methods of forming the polyesters into film(s) and/or sheet(s) are well known in the art. Examples of film(s) and/or sheet(s) useful the present invention include but not are limited to extruded film(s) and/or sheet(s), compression molded film(s), calendered film(s) and/or sheet(s), solution casted film(s) and/or sheet(s). In one aspect, methods of making film and/or sheet useful to produce the shrink films of the present invention include but are not limited to extrusion, compression molding, calendering, and solution casting.

In a further aspect, the invention provides a shrinkable film comprising a polyester composition comprising a polyester chosen from A. and B.:
A. a polyester comprising:
   a. a dicarboxylic acid component comprising:
      greater than about 75 mole percent of terephthalic acid residues;
      about 0 to about 25 mole percent of isophthalic acid residues; and
   b. a glycol component comprising:
      about 60 to about 90 mole percent of ethylene glycol residues; and
      about 0.1 to about 30 mole percent of residues chosen from 2,2-dimethylpropane-1,3-diol and 1,4-cyclohexanedimethanol residues; and
      about 0 to about 15 mole percent of total diethylene glycol residues; and
B. polyester comprising:
   a. a dicarboxylic acid component comprising:
      100 mole percent of diacid residues chosen from aliphatic, alicyclic, and aromatic dicarboxylic acids, provided that the aromatic dicarboxylic acids are other than terephthalic acid;
      and
   b. a glycol component comprising:
      100 mole percent of glycol residues;
      provided that the glycol component is comprised of less than about 23 mole percent of glycol residues capable of forming amorphous segments in the polyester;
wherein the polyester composition has an inherent viscosity of about 0.5 to about 0.9 dL/g, measured in a 60/40 parts by weight solution of phenol/tetrachloroethane, at 250° C. and at a concentration of about 0.5 g of polymer in 100 mL of solution;
and wherein, the film, when having a pre-oriented thickness of about 100 to 400 microns and then oriented on a tenter frame at a ratio of 6.5:1 to 3:1, at a temperature of from the glass transition temperature of the polyester to about 55° C. greater than the glass transition temperature of the polyester and to a thickness of from about 20 to about 80 microns, the shrink film exhibits the following properties:
   1. a total TD shrinkage at 95° C. of less than or equal to 60%;
   2. a shrink force of greater than about 7.7 MPa;
   3. an MD shrinkage of less than or equal to 10%; and
   4. a crystalline melting point of about 190° C. to about 240° C.; and
wherein the total mole percent of the dicarboxylic acid component is 100 mole percent, and wherein the total mole percent of the glycol component is 100 percent.

In another embodiment, the shrinkable films exhibit the properties 1 through 5 above, when measured at a temperature of from the glass transition temperature of the polyester to about 20° C. greater than the glass transition temperature of the polyester.

As used herein, the reference to “total TD shrinkage at 95° C. of less than or equal to 60” refers to a shrinkage determined according to the following methodology:
Shrinkage is measured by placing a 50 mm by 50 mm square film sample in water at temperatures ranging from 65° C. to 95° C. for 10 seconds without restricting shrinkage in any direction. The percent shrinkage was then calculated by the following equation:

$$\% shrinkage = [ ( 50 mm - length after shrinkage ) / 50 mm ] \times 100 \%$$

Shrinkage is measured in the direction orthogonal to the main shrinkage direction (machine direction, MD) and was also measured in the main shrinkage direction (transverse direction, TD).
Negative shrinkage indicates growth

As noted above, the films exhibit a shrink force of from greater than about 7.7 MPa, as measured by ISO Method 14616 depending on the stretching conditions and the end-use application desired. For example, certain labels made for plastic bottles can have an MPa of from 4 to 8 and certain labels made for glass bottles can have a shrink force of from 8 to 14 MPa as measured by ISO Method 14616 using a Shrink Force Tester made by LabThink at 80° C.

Additionally, the films of the invention exhibit a shrink rate at about 65 to 80° C. of les than or equal to about 4% per° C. In this regard, Shrink Rate=(shrinkage at 80° C.−shrinkage at 65° C.)/15° C.=% ° C.

The films of the invention also exhibit an MD shrinkage of less than or equal to 10%. In this regard, “MD shrinkage” is determined in the same manner as described for TD shrinkage above. However, while MD shrinkage is defined as the shrinkage in the main shrinkage direction, TD shrinkage is defined as shrinkage orthogonal to the main shrinkage direction.

In certain shrinkable film embodiments, the glycol residues capable of forming amorphous segments in the polyester are chosen from residues of 2,2,4-trimethyl-1,3-pentanediol; 2-propoxy-1,3-propanediol; 2-methyl-2-propyl-1,3-propanediol; 2,2-dimethyl-1,3-propanediol; diethylene glycol; 1,4-cyclohexanedimethanol; 1,3-cyclohexanedimethanol; 2,2′,4,4′-tetramethyl-1,3-cyclobutanediol; dimers of cyclohexanedimethanol; triethylene glycol; 1,3-propanediol; 2-methyl-1,3-propanediol; 1,4-butanediol; 2-propoxy-1,3-propanediol; 2-propoxy 1,3-propanediol; polytetramethylene ether glycol; and polyethylene glycol.

In another shrinkable film embodiment, A. is a polyester comprising:
a. a dicarboxylic acid component comprising greater than about 90 mole percent of terephthalic acid residues;
b. a glycol component comprising: about 75 mole percent to about 90 mole percent of ethylene glycol residues; about 0.1 to about 20 mole percent of residues chosen from either 2,2-dimethyl-1,3-propanediol or 1,4-cyclohexanedimethanol; and about 0 to about 5 mole percent of total diethylene glycol residues.

In another shrinkable film embodiment, the glycol component further comprises about 0.1 to about 4 mole percent of total diethylene glycol residues.

In another embodiment, the glycol component of polyester A. or polyester B., above, is comprised of about 80 to about 85 mole percent of ethylene glycol residues, about 3 to about 5 mole percent of total diethylene glycol residues, about 1.7 to about 2.4 mole percent of 1,4-cyclohexanedimethanol residues, and about 9 to about 13 mole percent of 2,2-dimethyl-1,3-propanediol residues.

In another embodiment, the glycol component of polyester A. or polyester B., above, is comprised of about 77 to about 83 mole percent of ethylene glycol residues, about 5 to about 7 mole percent of total diethylene glycol residues, and about 13 to about 16 mole percent of 2,2-dimethyl-1,3-propanediol residues.

In another shrinkable film embodiment, B. b. is comprised of about 80 to about 90 mole percent of ethylene glycol residues; about 2.8 to about 7.5 mole percent of diethylene glycol residues; from 0 to about 2.5 mole percent of 1,4-cyclohexanedimethanol; and 9 to about 12 mole percent of 2,2-dimethyl-1,3-propanediol.

In another shrinkable film embodiment, B. b. is comprised of about 75 to about 85 mole percent of ethylene glycol residues; about 2.8 to about 7.4 mole percent of diethylene glycol residues; from 0 to about 6.2 mole percent of 1,4-cyclohexanedimethanol; and 9 to about 17 mole percent of 2,2-dimethyl-1,3-propanediol.

In another shrinkable film embodiment, the polyester composition comprises a polyester comprising:
a. a dicarboxylic acid component comprising:
   about 95 to about 100 mole percent of terephthalic acid residues; and
   about 0 to about 5 mole percent of diacid residues chosen from residues of adipic acid, succinic acid, glutaric acid, azelaic acid, sebacic acid, 1,3-cyclohexanedicarboxylic acid, isophthalic acid. 1,4-cyclohexanedicarboxylic acid, and hexahydrophthalic anhydride
b. a glycol component comprising:
   about 80 to about 88 mole percent of ethylene glycol residues;
   about 9 to about 13 mole percent of residues of 2,2-dimethylpropane-1,3-diol; and
   about 3 to about 7 mole percent of total diethylene glycol residues; and
wherein the total mole percent of the dicarboxylic acid component is 100 mole percent, and wherein the total mole percent of the glycol component is 100 percent.

In another shrinkable film embodiment, the dicarboxylic acid component comprises about 0 to about 5 mole percent of residues of isophthalic acid.

In another shrinkable film embodiment, the shrinkable film comprises a polyester blend comprising:
(a) from 5 to 95 weight % of the polyester composition of claim 1; and
(b) from 5 to 95 weight % of at least one polyester composition which is other than the polyester compositions of claim 1;
with the proviso that the total mole percent of glycol residues capable of forming amorphous segments in the total of (a) and (b) is less than about 23 mole percent.

In another aspect, the invention provides a molded article, thermoformed sheet, extruded sheet, or film, comprising the polyesters of the various embodiments herein. In general, the term “film” refers to a thin film capable of being rolled, whereas a sheet refers to an article which is too thick to be rolled. In certain embodiments, films of the invention are about 40 microns to about 250 microns thick. In certain embodiments, sheets of the invention are about 1250 microns to about 0.75 inches in thickness.

The shrink films of the invention can have an onset of shrinkage temperature of from about 55 to about 80° C., or about 55 to about 75° C., or about 55 to about 70° C. Onset shrinkage temperature is the lowest temperature at which shrinkage occurs.

In certain embodiments, the polyesters of the invention can have densities of 1.6 g/cc or less, or 1.5 g/cc or less, or 1.4 g/cc or less, or 1.1 g/cc to 1.5 g/cc, or 1.2 g/cc to 1.4 g/cc, or 1.2 g/cc to 1.35 g/cc. In one embodiment, the polyesters of the invention have densities of 1.2 g/cc to 1.3 g/cc.

One approach for reducing the density is to introduce many small voids or holes into the shaped article. This process is called “voiding” and may also be referred to as “cavitating” or “microvoiding”. Voids are obtained by incorporating about 5 to about 50 weight % of small organic or inorganic particles or “inclusions” (referred in the art as “voiding” or “cavitation” agents) into a matrix polymer and orienting the polymer by stretching in at least one direction. Additionally, the use of immiscible or incompatible resins can create voids. During stretching, small cavities or voids are formed around the voiding agent. When voids are introduced into polymer films, the resulting voided film not only has a lower density than the non-voided film, but also becomes opaque and develops a paper-like surface. This surface also has the advantage of increased printability; that is, the surface is capable of accepting many inks with a substantially greater capacity over a non-voided film. Typical examples of voided films are described in U.S. Pat. Nos. 3,426,754; 3,944,699; 4,138,459; 4,582,752; 4,632,869; 4,770,931; 5,176,954; 5,435,955; 5,843,578; 6,004,664; 6,287,680; 6,500,533; 6,720,085; each of which is incorporated herein by reference, along with U.S. Patent Application Publication Numbers 2001/0036545; 2003/0068453; 2003/0165671; 2003/0170427; Japan Patent Application No.'s 61-037827; 63-193822; 2004-181863; European Patent No. 0 581 970 B1, and European Patent Application No. 0 214 859 A2.

In certain embodiments, the as-extruded films are oriented while they are stretched. The oriented films or shrinkable films of the present invention can be made from films having any thickness depending on the desired end-use. The desirable conditions are, in one embodiment, where the oriented films and/or shrinkable films can be printed with ink for applications including labels, photo films which can be adhered to substrates such as paper, and/or other applications that it may be useful in. It may be desirable to coextrude the polyesters useful in the present invention with another polymer, such as PET, to make multilayer films useful in making the oriented films and/or shrink films of this disclosure. One advantage of doing the latter is that a tie layer may not be needed in some embodiments. Another advantage of a multilayer film is that is combines the performance of dissimilar materials into a single structure.

In one embodiment, the monoaxially and biaxially oriented films of the present invention can be made from films having a thickness of about 100 to 400 microns, for example, extruded, cast or calendared films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as-extruded film can be performed on a tenter frame according to these orientation conditions. The shrink films of the present invention can be made from the oriented films as described herein.

In certain embodiments of the invention, the shrink films have shrinkage in the machine direction of less than or equal to 10. In certain embodiments, the shrink films have shrinkage in the machine direction of from 10% to −10%, 10% to −5%, 10% to 0%, 8% to −8%, 5% to −5%, or no shrinkage . . . −15% to 5%, −5% to 4%, −5% to 3%, or −5% to 2.5%, or −5% to 2%, or −4% to 4%, or −3% to 4% or −2% to 4%, or −2% to 2.5%, or −2% to 2%, or 0 to 2%, or no shrinkage, when immersed in water at 65° C. for 10 seconds. Negative machine direction shrinkage percentages here indicate machine direction growth. Positive machine direction shrinkages indicate shrinkage in the machine direction.

In one embodiment, the polyester compositions of the invention are made into films using any method known in the art to produce films from polyesters, for example, solution casting, extrusion, compression molding, or calendering. The as-extruded (or as-formed) film is then oriented in one or more directions (e.g., monoaxially and/or biaxially oriented film). This orientation of the films can be performed by any method known in the art using standard orientation conditions. For example, the monoaxially oriented films of the present invention can be made from films having a thickness of about 100 to 400 microns, such as, extruded, cast or calendered films, which can be stretched at a ratio of 6.5:1 to 3:1 at a temperature of from the Tg of the film to the Tg+55° C., and which can be stretched to a thickness of 20 to 80 microns. In one embodiment, the orientation of the initial as-extruded film can be performed on a tenter frame according to these orientation conditions.

In certain embodiments, the shrink films of this invention have less than or equal to 60% shrinkage in the transverse direction measured at 95° C.

In certain embodiments, the shrink films can have an onset of shrinkage temperature of from about 55 to about 80° C., or about 55 to about 75° C., or 55 to about 70° C. “Onset of shrinkage temperature” is the temperature at which onset of shrinking occurs.

In certain embodiments, the shrink films can have an onset of shrinkage temperature of between 55° C. and 70° C.

In certain embodiments, the shrink films can have a break strain percentage greater than 100% at a stretching speed of 300 mm/minute in the direction orthogonal to the main shrinkage direction according to ASTM Method D882.

In certain embodiments, the shrink films can have a break strain percentage of greater than 300% at a stretching speed of 300 mm/minute in the direction orthogonal to the main shrinkage direction according to ASTM Method D882.

In certain embodiments, the shrink films can have a tensile stress at break (break stress) of from 20 to 400 MPa; or 40 to 260 MPa; or 42 to 260 MPa as measured according to ASTM Method D882.

In certain embodiments, the shrink films can have a shrink force of from greater than about 7.7 MPa, as measured by ISO Method 14616 depending on the stretching conditions and the end-use application desired. For example, certain labels made for plastic bottles can have an MPa of from 4 to 8 and certain labels made for glass bottles can have a shrink force of from 8 to 14 MPa as measured by ISO Method 14616 using a Shrink Force Tester made by LabThink at 80° C.

Reinforcing materials can be added to the polyester compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

Molded articles can also be manufactured from any of the polyesters disclosed herein which may or may not consist of or contain shrink films and are included within the scope of the present invention.

Optionally, the shrink films of the invention may contain from 0.01 to 10 weight percent of a polyester plasticizer, when present. In this regard, useful polyester plasticizers can be those described in U.S. Pat. No. 10,329,395, incorporated herein by reference. In general, such polyester plasticizers are characterized by comprising (i) a polyol component comprising residues of a polyol having 2 to 8 carbon atoms, and (ii) a diacid component comprising residues of a dicarboxylic acid having 4 to 12 carbon atoms. In one embodiment, the shrink films can contain from 0.1 to 5 weight percent of the polyester plasticizer. Generally, the shrink films can contain from 90 to 99.99 weight percent of the copolyester. In certain embodiments, the shrink films can contain from 95 to 99.9 weight percent of the copolyester.

The shrinkage percentages recited herein are based on initial pre-shrunk films having a thickness of about 20 to 80 microns that have been oriented at a ratio of from 6.5:1 to 3:1 at a temperature of from the glass transition temperature of the polyester to about 55° C. greater than the glass transition temperature of the polyester, on a tenter frame, for example, at a ratio of 5:1 at a temperature from 70° C. to 85° C. In one embodiment, the shrinkage properties of the oriented films used to make the shrink films of this disclosure were not adjusted by annealing the films at a temperature higher than the temperature in which it was oriented. In another embodiment, the film properties are adjusted by annealing, by heat treatment before or after stretching.

The shape of the films useful in making the oriented films or shrink films of the present invention is not restricted in any way. For example, it may be a flat film or a film that has been formed into a tube. In order to produce the shrink films useful in the present invention, the polyester is generally first formed into a flat film and then is “uniaxially stretched”, meaning the polyester film is oriented in one direction. The films could also be “biaxially oriented,” meaning the polyester films are oriented in two different directions; for example, the films are stretched in both the machine direction and a direction different from the machine direction. Typically, but not always, the two directions are substantially perpendicular. For example, in one embodiment, the two directions are in the longitudinal or machine direction (“MD”) of the film (the direction in which the film is produced on a film-making machine) and the transverse direction (“TD”) of the film (the direction orthogonal to the MD of the film). Biaxially oriented films may be sequentially oriented, simultaneously oriented, or oriented by some combination of simultaneous and sequential stretching.

The films may be oriented by any usual method, such as the roll stretching method, the long-gap stretching method, the tenter-stretching method, and the tubular stretching method. With use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also, the stretching may be done first in one direction and then in the other direction to result in effective biaxial stretching. In one embodiment, stretching of the films is done by preliminarily heating the films at a temperature which is from their Tg to 55° C. above their glass transition temperature (Tg). In one embodiment, the films can be preliminarily heated from 10° C. to 30° C. above their Tg. In one embodiment, the stretch rate is from 0.5 to 20 inches (1.27 to 50.8 cm) per second. Next, the films can be oriented, for example, in either the machine direction, the transverse direction, or both directions from 2 to 6 times the original measurements. The films can be oriented as a single film layer or can be coextruded with another polyester such as PET (polyethylene terephthalate) as a multilayer film and then oriented.

In another aspect, the invention provides an article of manufacture or a shaped article comprising the polyester compositions of any of the embodiments as set forth herein.

In certain embodiments, the shrinkable films of this invention can be formed into a label or sleeve. The label or sleeve can then be applied to an article of manufacture, such as, the wall of a container, battery, or onto a sheet or film. Accordingly, in another aspect, the invention provides an article of manufacture, a shaped article, a container, a plastic bottle, a cup, a glass bottle, packaging, a battery, a hot fill container, or an industrial article, having applied thereto a label or sleeve, wherein said label or sleeve is comprised of the shrink film of the invention as set forth herein in various embodiments. For example, the shrink films of the present invention can be used in many packaging applications where the shaped article exhibits properties, such as, good printability, high opacity, higher shrink force, good texture, and good stiffness.

Accordingly, the compositions of the invention thus provide a combination of improved shrink properties as well as improved toughness, and thus are expected to offer new commercial options, including but not limited to, shrink films applied to containers, plastic bottles, glass bottles, packaging, batteries, hot fill containers, and/or industrial articles or other applications.

Film fabrication is accomplished by all known means to convert resin samples to films. For small, lab-scale samples, lab-scale pressing and stretching methods can be utilized. Polymer pellets can be melted at a temperature of 220° C. to 290° C. or from 240° C. to 260° C. and shaped into a film of desired dimensions. For larger samples, copolyester samples can be extruded using single or twin-screw extruders into film at temperatures between about 220° and 290° C. The resulting films (made using extrusion process) may be stretched 2 to 6 times the original dimensions in the direction orthogonal to the extruded or machine direction at a temperature from the Tg of the resin to the Tg+55° C. For film made using the lab-scale process that lack a true machine direction, the samples can be stretched 2 to 6 times the original dimensions in either direction at a temperature from the Tg of the resin to the Tg+55° C. In both cases, preferably stretched in one direction by about 3-5 times more than the orthogonal direction at a temperature from the Tg of the resin to the Tg+55° C. The thickness of the heat-shrinkable polyester film prepared in accordance with the present invention may be 20 μm to 80 μm, or 30 μm to 50 μm.

This invention can be further illustrated by the following examples, although it will be understood that these examples are included merely for purposes of illustration and are not intended to limit the scope of the invention unless otherwise specifically indicated.

### EXAMPLES

### TPA/EG Oligomer Synthesis

Terephthalic acid (TPA)/ethylene glycol (EG) oligomers were made by feeding a single continuous stirred tank reactor (CSTR reactor) a slurry of PTA and EG continuously. The CSTR reactor level was kept constant via continuous removal of the TPA/EG oligomer product and separation/removal of the water of reaction via distillation. For lab resin synthesis, TPA/EG oligomer is a combination of several batches. The table below shows a summary of feed ratio, rate and process conditions (as well as analytical results) for the oligomer batches that combined for resin synthesis.

TABLE 1
Composition details for the TPA/EG Oligomer:

| | Feed mole | Free PTA | EG | DEG | Product | Product | Residence |
|---|---|---|---|---|---|---|---|
| Sample* | ratio | (wt. %) | (mole %) | (mole %) | mole ratio | rate (g/min.) | Time (hours) |
| A | 1.4 | 1.73 | 98.0 | 2.0 | 1.18 | 9.69 | 3.9 |
| B | 1.4 | 4.36 | 98.5 | 1.5 | 1.20 | 16.12 | 2.3 |
| C | 1.4 | 5.29 | 98.7 | 1.3 | 1.41 | 20.02 | 1.9 |
| D | 1.4 | 4.42 | 98.6 | 1.4 | 1.28 | 23.37 | 1.6 |

*In each case, the reactor temperature was 260° C., the reactor pressure was 30 psig, the column bottom temperature was 160° C., the column top temperature was 150° C., and the column partial condition temperature was 140° C.

### Copolyester Synthesis

Polymerizations were conducted with titanium isopropoxide diluted in ethylene glycol (0.33% concentration by weight) The Camille recipe is shown in Table 2. To make comparative example 1 with a target glycol composition containing 65 mole % EG, 23 mole % CHDM, and 12 mole % DEG, TPA/EG oligomer (100 g, 0.4 mol), CHDM (17.58 g, 0.122 mol), DEG (6.72 g, 0.06 mol) and 0.33 wt % Ti solution (0.5 g) were charged into a 500 mL round bottom flask. The reaction vessel was then equipped with a nitrogen inlet and a stainless steel stirrer. The sidearm was attached to a condenser that was connected to a vacuum flask. After set-up of the polymerization, all reactions were performed on computer automated polymer rigs equipped with Camille Tg™ software. Merpol® A surfactant (Stepan Company) was added to the reaction bottle through the side arm at stage 4. The exact polymer composition and inherent viscosity (IhV) were analyzed. The polymer was then ground into powder (max 6 mm particle size) to facilitate pressing polymer films.

TABLE 2
Camille recipe for resin synthesis (left table
recipe is for resins made from TPA/EG oligomer

| | Time | Temperature | Pressure | Stir |
|---|---|---|---|---|
| Stage No. | (minutes) | (° C.) | (psi) | (rpm) |
| 1 | 0.1 | 265 | 730 | 0 |
| 2 | 8 | 265 | 730 | 125 |
| 3 | 60 | 265 | 730 | 150 |
| 4 (P addition) | 2 | 265 | 730 | 150 |
| 5 | 5 | 265 | 130 | 150 |
| 6 | 40 | 265 | 130 | 150 |
| 7 | 8 | 275 | 4 | 125 |
| 8 | 42 | 275 | 4 | 75 |
| 9 | 5 | 275 | 0.6 | 75 |
| 10 | 80-120 | 275 | 0.6 | 75 |
| 11 | 2 | 275 | 730 | 0 |

### Film Forming Procedure:

Films were produced from ground polymer using a manual press. Ground polymer was dried overnight at 55° C. in a vacuum oven and subsequently pressed into 10 mil films according to the following procedure:
1. Heat manual press to 250° C.;
2. Weigh out ˜8 g of ground polymer and place in the center of a 6″ by 6″ by 10 mil shim; Assemble the shim and polymer according to the following configuration: press plate, Kapton film, shim and polymer, Kapton film, press plate;
3. Place the preceding configuration between the platens of the manual press and melt the polymer under nominal pressures for approximately 2 minutes;
4. Increase the pressure to 12,000 psi and maintain pressure for approximately 45 seconds;
5. Rapidly release pressure to 0 psi and then immediately increase the pressure to 13,000 psi; Rapidly release pressure to 0 psi and then immediately increase pressure to 14,000 psi; Repeat these steps such that the pressure is continuously released to 0 psi and subsequently increased in increments of 1,000 psi until a final pressure of 16,000 psi is achieved;
6. Hold pressure at 16,000 psi for approximately 45 seconds; then release pressure to 0 psi and remove polymer from press;
7. Cut resultant polymer film out of the shim;
8. Repeat film pressing as necessary.

Pressed films were cut into 181 mm by 181 mm squares and stretched on a Bruckner Karo 4 tenter frame to a final thickness of 50 microns. The films were stretched at a 5:1 ratio, with a stretch rate of 181 mm/sec, and a stretch temperature 0-20 degrees Celsius above the Tg of the extruded film with a 10-second preheat soak time prior to stretching.

Stretched films were submitted for analysis via differential scanning calorimetry (DSC). Glass transition temperature and the strain induced crystalline melting point (Tg and Tm respectively) were measured
ASTM E1356
Determined using a TA DSC 2920 from Thermal Analyst Instrument at a scan rate of 20° C./min.
Tm was measured on the first heat of stretched samples
Tg was measured during the 2nd heating step.

### Shrink Film Property Test

### Shrink Force

Shrink force was determined using a Labthink FST-02 shrink force tester. Shrink force measurements were conducted under the same temperature conditions as the stretching temperatures used to stretch films on the Bruckner (Tg+0 to 20° C.) and held in the heating chamber for 60 seconds—just long enough to measure the maximum shrink force value of each film.

### Shrinkage

Shrinkage was measured by placing a 50 mm by 50 mm square film sample in water at temperatures ranging from 65° C. to 95° C. for 10 seconds without restricting shrinkage in any direction. The percent shrinkage was then calculated by the following equation:

$$\% shrinkage = [ ( 50 mm - length after shrinkage ) / 50 mm ] \times 100 \%$$

Shrinkage was measured in the main shrinkage (transverse direction, TD) and in the direction orthogonal to the main shrinkage direction (machine direction, MD).
Negative shrinkage indicated growth

### Comparative Examples

The composition and film properties of comparative example 1 is shown in Table 3 and Table 4, respectively. This example is a typical PETG shrink film resin.

TABLE 3
Comparative Example Composition

| Example | Comparative Example 1 |
|---|---|
| Diacid/Diester | |
| Terephthalic acid | 100 |
| Diol/Glycols | |
| Ethylene glycol | 65 |
| Cyclohexanedimethanol | 23 |
| Diethylene glycol | 12 |

TABLE 4
Shrinkable Film Properties of Film
Made with Comparative Example 1

| | | Comparative example | |
|---|---|---|---|
| Example | | 1 (C-1) | |
| Intrinsic viscosity (dL/g) | | 0.69 | |
| Glass transition temperature (° C.) | | 71 | |
| | Temp (° C.) | MD | TD |
| Heat Shrinkage (%) | 60 | 0 | 1 |
| | 65 | 1 | 2 |
| | 70 | 1 | 21 |
| | 75 | −8 | 48 |
| | 80 | −13 | 65 |
| | 85 | −11 | 73 |
| | 90 | −12 | 77 |
| | 95 | −5 | 78 |

| | |
|---|---|
| Shrink force (Mpa, <7.7) | 7.7 |

### Examples 1-4: Amorphous Monomer Content Less than 20 Mole %

These examples describe polyester resins that can be converted into shrinkable films that meet the requirements for shrink film applications described by this invention. Compared to the shrink film properties data for comparative example 1, examples 1-4 have ultimate shrinkages less than 60% and a strain induced melting point greater than or equal to 200° C.

TABLE 5
Resin compositions with Amorphous Monomer content below 20%

| Patent example | | Example 1 | | Example 2 | | Example 3 | | Example 4 | |
|---|---|---|---|---|---|---|---|---|---|
| Composi- | EG, | 82.4 | | 80.4 | | 86.9 | | 83.3 | |
| tion | Mole % | | | | | | | | |
| (Resin) | DEG, | 4.2 | | 7.2 | | 3.0 | | 7.0 | |
| | Mole % | | | | | | | | |
| | TEG, | 0.0 | | 0.0 | | 0.0 | | 0.0 | |
| | Mole % | | | | | | | | |
| | CHDM, | 2.1 | | 1.2 | | 0.0 | | 0.0 | |
| | Mole % | | | | | | | | |
| | NPG, | 11.3 | | 11.2 | | 10.1 | | 9.7 | |
| | Mole % | | | | | | | | |
| | Amorphous | 17.6 | | 19.6 | | 13.1 | | 16.7 | |
| | monomer | | | | | | | | |
| | content | | | | | | | | |
| | (%) | | | | | | | | |
| | Temp | MD | TD | MD | TD | MD | TD | MD | TD |
| Shrinkage | 60 | 0 | 0 | 0 | 0 | 0 | 1 | 0 | 1 |
| (%) | 65 | 0 | 1 | 0 | 2 | 0 | 2 | 0 | 1 |
| | 70 | 2 | 5 | 1 | 6 | 1 | 3 | 1 | 5 |
| | 75 | 2 | 12 | 2 | 20 | 2 | 8 | 2 | 14 |
| | 80 | 0 | 36 | −2 | 38 | 2 | 22 | 1 | 30 |
| | 85 | −2 | 44 | −2 | 48 | 2 | 34 | 0 | 40 |
| | 90 | −1 | 55 | −3 | 54 | −1 | 45 | 1 | 45 |
| | 95 | 0.5 | 58 | 1 | 58 | 0 | 50 | 0 | 50 |
| Labthink | | 9.8 | | | | 8.4 | | 8.5 | |
| SF@ | | | | | | | | | |
| 80° C. | | | | | | | | | |
| (MPa) | | | | | | | | | |
| DSC | Tg (° C.) | 75.7 | | 73.7 | | 76.9 | | 73.5 | |
| (Stretched | | | | | | | | | |
| Film) | | | | | | | | | |
| DSC | Tm (° C.) | 208.0 | | 199.8 | | 219.6 | | 210.2 | |
| (Stretched | | | | | | | | | |
| Film) | | | | | | | | | |
| Inherent | dL/g | 0.73 | | 0.74 | | 0.75 | | 0.77 | |
| Viscosity | | | | | | | | | |

TABLE 6
Shrinkable Film Properties of Film Made with Resin compositions
with Amorphous Monomer content from 20 to <23%

| | | | | | | | | | |
|---|---|---|---|---|---|---|---|---|---|
| Example No. | | Example 5 | | Example 6 | | Example 7 | | Example 8 | |
| NMR | EG, Mole % | 77.4 | | 78.7 | | 79.0 | | 79.6 | |
| (Resin) | DEG, Mole % | 7.2 | | 4.9 | | 4.9 | | 5.9 | |
| | TEG, Mole | 0.0 | | 0.0 | | 0.0 | | 0.0 | |
| | % | | | | | | | | |
| | CHDM, | 2.9 | | 3.1 | | 0.0 | | 0.0 | |
| | Mole % | | | | | | | | |
| | NPG, Mole % | 12.5 | | 13.3 | | 16.1 | | 14.5 | |
| | Amorphous | 22.6 | | 21.3 | | 21.0 | | 20.4 | |
| | monomer | | | | | | | | |
| | content (%) | | | | | | | | |
| Shrinkage | Temp | MD | TD | MD | TD | MD | TD | MD | TD |
| (%) | 60 | 0 | 1 | 0 | 0 | 0 | 0 | 0 | 1 |
| | 65 | 0 | 2 | 0 | 1 | 0 | 2 | 0 | 2 |
| | 70 | 0 | 8 | 1 | 7 | 1 | 7 | 1 | 6 |
| | 75 | 0 | 28 | 2 | 26 | -1 | 27 | 0 | 28 |
| | 80 | -6 | 48 | -3 | 36 | -3 | 45 | -3 | 43 |
| | 85 | -3 | 57 | -5 | 59 | -7 | 59 | -2 | 56 |
| | 90 | -4 | 64 | -5 | 62 | -7 | 66 | -2 | 62 |
| | 95 | -2 | 65 | -4 | 68 | -5 | 69 | -2 | 65 |
| Labthink SF@ 80° C. | | 8.6 | | 8.7 | | 10.2 | | 9.8 | |
| (MPa) | | | | | | | | | |

| | | | | | |
|---|---|---|---|---|---|
| Example No. | | Example 5 | Example 6 | Example 7 | Example 8 |
| DSC | Tg (° C.) | 73.1 | 75.0 | 74.8 | 74.2 |
| (Stretched | | | | | |
| Film) | | | | | |
| DSC | Tm (° C.) | 193.5 | 194.9 | 194.4 | 198.7 |
| (Stretched | | | | | |
| Film) | | | | | |
| Inherent | dL/g | 0.74 | 0.75 | 0.76 | 0.76 |
| Viscosity | | | | | |

TABLE 7
Resin compositions with Amorphous Monomer content >23%

| | | | | | | | | | | | |
|---|---|---|---|---|---|---|---|---|---|---|---|
| Example No. | | Example 9 | | Example 10 | | Example | | Example | | Example | |
| | | | | | | 11 | | 12 | | 13 | |
| NMR | EG, Mole % | 76.3 | | 75.1 | | 76.8 | | 76.4 | | 71.4 | |
| (Resin) | DEG, | 4.8 | | 3.2 | | 4.0 | | 6.8 | | 7.0 | |
| | Mole % | | | | | | | | | | |
| | TEG, Mole | 0.0 | | 0.0 | | 0.0 | | 0.0 | | 0.0 | |
| | % | | | | | | | | | | |
| | CHDM, | 5.9 | | 5.8 | | 3.0 | | 1.1 | | 6.0 | |
| | Mole % | | | | | | | | | | |
| | NPG, | 13.0 | | 15.9 | | 16.2 | | 15.7 | | 15.6 | |
| | Mole % | | | | | | | | | | |
| | Amorphous | 23.7 | | 24.9 | | 23.2 | | 23.6 | | 28.6 | |
| | monomer | | | | | | | | | | |
| | content (%) | | | | | | | | | | |
| (%) | Temp | MD | TD | MD | TD | MD | TD | MD | TD | MD | TD |
| | 60 | 0 | 1 | 0 | 0 | 0 | 0 | 0 | 1 | 0 | 2 |
| | 65 | 0 | 2 | 0 | 2 | 0 | 2 | 0 | 2 | 0 | 4 |
| | 70 | 2 | 12 | 0 | 6 | 1 | 10 | 1 | 14 | - | 20 |
| | | | | | | | | | | 0.5 | |
| | 75 | 2 | 23 | 0 | 22 | -1 | 34 | -2 | 36 | -8 | 47 |
| | 80 | -7 | 52 | -7 | 51 | -7 | 51 | -6 | 54 | -10 | 62 |
| | 85 | -8 | 64 | -10 | 66 | -9 | 70 | -6 | 66 | -10 | 74 |
| Shrinkage | 90 | -6 | 71 | -8 | 75 | -6 | 74 | -3 | 71 | -4 | 76 |
| | 95 | -5 | 76 | -8 | 77 | -3 | 76 | -2 | 75 | -6 | 79 |
| Labthink SF@ 80° C. | | 9.3 | | 9.3 | | 10.8 | | 10.0 | | 9.1 | |
| (MPa) | | | | | | | | | | | |
| DSC | Tg (° C.) | 75.4 | | 76.3 | | 75.9 | | 73.4 | | 73.4 | |
| (Stretched | | | | | | | | | | | |
| Film) | | | | | | | | | | | |
| DSC | Tm (° C.) | 188.5 | | 186.0 | | 189.5 | | 186.7 | | 175.2 | |
| (Stretched | | | | | | | | | | | |
| Film) | | | | | | | | | | | |
| Inherent | dL/g | 0.77 | | 0.74 | | 0.77 | | 0.77 | | 0.74 | |
| Viscosity | | | | | | | | | | | |

TABLE 8
Shrinkable Film Properties of Film Made with Resin compositions
with Amorphous Monomer content >23% (cont'd)

| | | | | | | | | | |
|---|---|---|---|---|---|---|---|---|---|
| Example No. | | Example | | Example | | Example | | Example | |
| | | 14 | | 15 | | 16 | | 17 | |
| NMR | EG, Mole % | 77.8 | | 73.1 | | 77.3 | | 74.2 | |
| (Resin) | DEG, | 2.9 | | 6.9 | | 6.9 | | 7.0 | |
| | Mole % | | | | | | | | |
| | TEG, Mole | 0.0 | | 0.0 | | 0.0 | | 0.0 | |
| | % | | | | | | | | |
| | CHDM, | 5.0 | | 6.0 | | 5.8 | | 3.0 | |
| | Mole % | | | | | | | | |
| | NPG, | 14.3 | | 14.0 | | 10.0 | | 15.8 | |
| | Mole % | | | | | | | | |
| | Amorphous | 22.2 | | 26.9 | | 22.7 | | 25.8 | |
| | monomer | | | | | | | | |
| | content (%) | | | | | | | | |
| (%) | Temp | MD | TD | MD | TD | MD | TD | MD | TD |
| | | (21) | (21) | (23) | (23) | (25) | (25) | (28) | (28) |
| | 60 | 0 | 1 | 0 | 1 | 0 | 1 | 0 | 0 |
| | 65 | 0 | 2 | 0 | 2 | 0 | 2 | 0 | 3 |
| | 70 | 1 | 5 | 0 | 14 | 2 | 11 | 0 | 17 |
| | 75 | 0 | 22 | -5 | 40 | -1 | 34 | -5 | 43 |
| | 80 | -6 | 46 | -10 | 58 | -6 | 48 | -7 | 57 |
| | 85 | -11 | 66 | -9 | 69 | -6 | 60 | -6 | 68 |
| | 90 | -8 | 72 | -8 | 76 | -3 | 64 | -6 | 73 |
| Shrinkage | 95 | -8 | 76 | -6 | 78 | -7 | 72 | -2 | 76 |
| Labthink SF@ 80° C. | | 10.8 | | 9.5 | | 8.8 | | 8.4 | |
| (MPa) | | | | | | | | | |
| DSC | Tg (° C.) | 76.9 | | 73.0 | | 73.6 | | 73.0 | |
| (Stretched | | | | | | | | | |
| Film) | | | | | | | | | |
| DSC | Tm (° C.) | 191.0 | | 179.1 | | 191.5 | | 182.5 | |
| (Stretched | | | | | | | | | |
| Film) | | | | | | | | | |
| Inherent | dL/g | 0.77 | | 0.75 | | 0.75 | | 0.76 | |
| Viscosity | | | | | | | | | |

The invention has been described in detail with particular reference to certain embodiments thereof, but it will be understood that variations and modifications can be effected within the spirit and scope of the invention.

1. A polyester composition comprising a polyester chosen from A and B:
A. a polyester comprising:
a. a dicarboxylic acid component comprising:
greater than about 75 mole percent of terephthalic acid residues;
about 0 to about 25 mole percent of isophthalic acid residues; and
b. a glycol component comprising:
about 60 to about 90 mole percent of ethylene glycol residues; and
about 0.1 to about 30 mole percent of residues chosen from 2,2-dimethylpropane-1,3-diol residues and 1,4-cyclohexanedimethanol residues; and
about 0 to about 15 mole percent of total diethylene glycol residues; and
B. a polyester comprising:
a. a dicarboxylic acid component comprising:
100 mole percent of diacid residues chosen from aliphatic, alicyclic, and aromatic dicarboxylic acids, provided that the aromatic dicarboxylic acids are other than terephthalic acid;
and
b. a glycol component comprising:
100 mole percent of glycol residues;
provided that the glycol component comprises less than about 23 mole percent of glycol residues capable of forming amorphous segments in the polyester;
wherein the polyester composition has an inherent viscosity of about 0.5 to about 0.9 dL/g, measured in a 60/40 parts by weight solution of phenol/tetrachloroethane, at 250° C. and at a concentration of about 0.5 g of polymer in 100 ml of solution;
wherein the polyester exhibits a strain-induced crystalline melting point of about 190° C. to about 240° C.; and
wherein the total mole percent of the dicarboxylic acid component is 100 mole percent, and wherein the total mole percent of the glycol component is 100 percent.

2. The composition of claim 1, wherein the glycol residues capable of forming amorphous segments in the polyester are chosen from residues of 2,2,4-trimethyl-1,3-pentanediol; 2-propoxy-1,3-propanediol; 2-methyl-2-propyl-1,3-propanediol; 2,2-dimethyl-1,3-propanediol; diethylene glycol; 1,4-cyclohexanedimethanol; 1,3-cyclohexanedimethanol; 2,2′,4,4′-tetramethyl-1,3-cyclobutanediol; dimers of cyclohexanedimethanol; triethylene glycol; 1,3-propanediol; 2-methyl-1,3-propanediol; 1,4-butanediol; 2-propoxy-1,3-propanediol; 2-propoxy 1,3-propanediol; polytetramethylene ether glycol; and polyethylene glycol.

3. The composition of claim 1, wherein A. is a polyester comprising:
a. a dicarboxylic acid component comprising greater than about 90 mole percent of terephthalic acid residues;
b. a glycol component comprising: about 75 mole percent to about 90 mole percent of ethylene glycol residues; about 0.1 to about 20 mole percent of residues chosen from either 2,2-dimethyl-1,3-propanediol or 1,4-cyclohexanedimethanol; and about 0 to about 5 mole percent of total diethylene glycol residues.

4. The composition of claim 2, wherein the glycol component further comprises about 0 to about 5 mole percent of total diethylene glycol residues.

5. The composition of claim 1, wherein B. a. is comprised of diacid residues chosen from residues of adipic acid, succinic acid, glutaric acid, azelaic acid, sebacic acid, 1,3-cyclohexanedicarboxylic acid, isophthalic acid, 1,4-cyclohexanedicarboxylic acid, and hexahydrophthalic anhydride; or wherein the glycol component of polyester A. or polyester B. is comprised of about 80 to about 85 mole percent of ethylene glycol residues, about 3 to about 5 mole percent of total diethylene glycol residues, about 1.7 to about 2.4 mole percent of 1,4-cyclohexanedimethanol residues, and about 9 to about 13 mole percent of 2,2-dimethyl-1,3-propanediol residues; or
wherein the glycol component of polyester A. or polyester B. is comprised of about 77 to about 83 mole percent of ethylene glycol residues, about 5 to about 7 mole percent of total diethylene glycol residues, and about 13 to about 16 mole percent of 2,2-dimethyl-1,3-propanediol residues; or wherein B. b. is comprised of about 68 to about 88 mole percent of ethylene glycol residues; about 2.8 to about 7.5 mole percent of diethylene glycol residues; from 0 to about 2.5 mole percent of 1,4-cyclohexanedimethanol; and 9 to about 12 mole percent of 2,2-dimethyl-1,3-propanediol; or
wherein B. b. is comprised of about 70 to about 88 mole percent of ethylene glycol residues; about 2.8 to about 7.5 mole percent of diethylene glycol residues; from 0 to about 6.2 mole percent of 1,4-cyclohexanedimethanol; and 9 to about 17 mole percent of 2,2-dimethyl-1,3-propanediol.

6. The composition of claim 1, wherein the polyester composition comprises a polyester comprising:
a. a dicarboxylic acid component comprising:
about 95 to about 100 mole percent of terephthalic acid residues;
about 0 to about 5 mole percent of diacid residues chosen from residues of adipic acid, succinic acid, glutaric acid, azelaic acid, sebacic acid, 1,3-cyclohexanedicarboxylic acid, isophthalic acid. 1,4-cyclohexanedicarboxylic acid, and hexahydrophthalic anhydride
b. a glycol component comprising:
about 80 to about 90 mole percent of ethylene glycol residues;
about 9 to about 13 mole percent of residues of 2,2-dimethylpropane-1,3-diol; and
about 3 to about 7 mole percent of total diethylene glycol residues; and
wherein the total mole percent of the dicarboxylic acid component is 100 mole percent, and wherein the total mole percent of the glycol component is 100 percent.

7. The polyester composition of claim 10, wherein the dicarboxylic acid component comprises about 0 to about 5 mole percent of residues of isophthalic acid.

8. A polyester blend comprising:
(a) from 5 to 95 weight % of the polyester composition of claim 1; and
(b) from 5 to 95 weight % of at least one polyester composition which is other than the polyester compositions of claim 1;
with the proviso that the total mole percent of glycol residues capable of forming amorphous segments in the total of (a) and (b) is less than about 23 mole percent; and wherein the blend exhibits a strain-induced crystalline melting point of about 190° C. to about 240° C.

9. The polyester composition of claim 1, wherein at least a portion of the dicarboxylic acid residues and/or glycol residues are derived from
(i) recycled monomeric species chosen from rDMT, rTPA, rDMI, rEG, rDEG, and rCHDM and (ii) rPET.

10. A shrinkable film comprising a polyester composition comprising a polyester chosen from A. and B.:
A. a polyester comprising:
a. a dicarboxylic acid component comprising:
greater than about 75 mole percent of terephthalic acid residues;
about 0 to about 25 mole percent of isophthalic acid residues; and
b. a glycol component comprising:
about 60 to about 90 mole percent of ethylene glycol residues; and
about 0.1 to about 30 mole percent of residues chosen from 2,2-dimethylpropane-1,3-diol and 1,4-cyclohexanedimethanol residues; and
about 0 to about 15 mole percent of total diethylene glycol residues; and
B. a polyester comprising:
a. a dicarboxylic acid component comprising:
100 mole percent of diacid residues chosen from aliphatic, alicyclic, and aromatic dicarboxylic acids, provided that the aromatic dicarboxylic acids are other than terephthalic acid;
and
b. a glycol component comprising:
100 mole percent of glycol residues;
provided that the glycol component comprises less than about 23 mole percent of glycol residues capable of forming amorphous segments in the polyester;
wherein the total mole percent of the dicarboxylic acid component is 100 mole percent, and wherein the total mole percent of the glycol component is 100 percent;
wherein the polyester composition has an inherent viscosity of about 0.5 to about 0.9 dL/g, measured in a 60/40 parts by weight solution of phenol/tetrachloroethane, at 250° C. and at a concentration of about 0.5 g of polymer in 100 mL of solution;
and wherein, the film, when having a pre-oriented thickness of about 100 to 400 microns and then oriented on a tenter frame at ratio of 6.5:1 to 3:1 at a temperature of from the glass transition temperature of the polyester to about 55° C. greater than the glass transition temperature of the polyester to a thickness of from about 20 to about 80 microns, the shrink film exhibits the following properties:
1. a total TD shrinkage at 95° C. of less than or equal to 70%;
2. a shrink force of less than about 7.7 Mpa;
3. an MD shrinkage of less than or equal to 10%; and
4. a strain-induced crystalline melting point of about 190° C. to about 240° C.

11. The shrinkable film of claim 10, wherein the glycol residues capable of forming amorphous segments in the polyester are chosen from residues of 2,2,4-trimethyl-1,3-pentanediol; 2-propoxy-1,3-propanediol; 2-methyl-2-propyl-1,3-propanediol; 2,2-dimethyl-1,3-propanediol; diethylene glycol; 1,4-cyclohexanedimethanol; 1,3-cyclohexanedimethanol; 2,2′,4,4′-tetramethyl-1,3-cyclobutanediol; dimers of cyclohexanedimethanol; triethylene glycol; 1,3-propanediol; 2-methyl-1,3-propanediol; 1,4-butanediol; 2-propoxy-1,3-propanediol; 2-propoxy 1,3-propanediol; polytetramethylene ether glycol; and polyethylene glycol.

12. The shrinkable film of claim 10, wherein A. is a polyester comprising:
a. a dicarboxylic acid component comprising greater than about 90 mole percent of terephthalic acid residues;
b. a glycol component comprising: about 75 mole percent to about 90 mole percent of ethylene glycol residues; about 0.1 to about 20 mole percent of residues chosen from either 2,2-dimethyl-1,3-propanediol or 1,4-cyclohexanedimethanol; and about 0 to about 5 mole percent of diethylene glycol residues.

13. The shrinkable film of claim 10, wherein, wherein the glycol component further comprises about 0 to about 5 mole percent of total diethylene glycol residues.

14. The shrinkable film of claim 10, wherein the glycol component of polyester A. or polyester B. is comprised of about 80 to about 85 mole percent of ethylene glycol residues, about 3 to about 5 mole percent of total diethylene glycol residues, about 1.7 to about 2.4 mole percent of 1,4-cyclohexanedimethanol residues, and about 9 to about 13 mole percent of 2,2-dimethyl-1,3-propanediol residues; or
wherein the glycol component of polyester A. or polyester B., above, is comprised of about 77 to about 83 mole percent of ethylene glycol residues, about 5 to about 7 mole percent of total diethylene glycol residues, and about 13 to about 16 mole percent of 2,2-dimethyl-1,3-propanediol residues; or
wherein B. b. is comprised of about 80 to about 90 mole percent of ethylene glycol residues; about 2.8 to about 7.5 mole percent of diethylene glycol residues; from 0 to about 2.5 mole percent of 1,4-cyclohexanedimethanol; and 9 to about 12 mole percent of 2,2-dimethyl-1,3-propanediol; or
wherein B. b. is comprised of about 75 to about 85 mole percent of ethylene glycol residues; about 2.8 to about 7.4 mole percent of diethylene glycol residues; from 0 to about 6.2 mole percent of 1,4-cyclohexanedimethanol; and 9 to about 17 mole percent of 2,2-dimethyl-1,3-propanediol.

15. The shrinkable film of claim 10, wherein the polyester composition comprises a polyester comprising:
a. a dicarboxylic acid component comprising:
about 95 to about 100 mole percent of terephthalic acid residues; and
about 0 to about 5 mole percent of dicarboxylic acid residues chosen from residues of adipic acid, succinic acid, glutaric acid, azelaic acid, sebacic acid, 1,3-cyclohexanedicarboxylic acid, isophthalic acid. 1,4-cyclohexanedicarboxylic acid, and hexahydrophthalic anhydride
b. a glycol component comprising:
about 80 to about 90 mole percent of ethylene glycol residues;
about 9 to about 13 mole percent of residues of 2,2-dimethylpropane-1,3-diol; and
about 3 to about 7 mole percent of diethylene glycol residues; and
wherein the total mole percent of the dicarboxylic acid component is 100 mole percent, and wherein the total mole percent of the glycol component is 100 percent.

16. The shrinkable film of claim 15, wherein the dicarboxylic acid component comprises about 0 to about 5 mole percent of residues of isophthalic acid.

17. A shrinkable film comprising a polyester blend comprising:
(a) from 5 to 95 weight % of the polyester composition of claim 1; and
(b) from 5 to 95 weight % of at least one polyester composition which is other than the polyester compositions of claim 1;
with the proviso that the total mole percent of glycol residues capable of forming amorphous segments in the total of (a) and (b) is less than about 23 mole percent.

18. An article of manufacture comprising the composition of claim 1 or claim 8.

19. The article of claim 18, wherein the article is chosen from a shaped or molded article, an extruded sheet, or film.

20. The article of claim 18, further comprising a label or sleeve applied thereto, wherein the label or sleeve is comprised of the shrink film of claim 10 or 17.
